(19) United States
(12) Patent Application Publication
(10) Pub. No.: US 2003/0136643 A1
(43) Pub. Date: Jul. 24, 2003

(54) Dynamically variable diameter, drive roller mounting system for companioned-belt speed synchronization, and a method of operating the same

(75) Inventors: Willson L. Mayerberg II, Skiatook, OK (US); Dennis Paul Gillespie, Sand Spring, OK (US)

Correspondence Address: Steven W. Weinrieb, SCHWARTZ & WEINRIEB, 2001 Jefferson Davis Highway, Crystal Plaza One, Suite 1109, Arlington, VA, 22202, US

(73) Assignee: LOCKHEED MARTIN CORPORATION

(21) Appl. No.: 10/050,785

(22) Filed: Jan. 18, 2002

(51) Int. Cl. B65G 37/00

(52) U.S. Cl. 198/620

(57) ABSTRACT

A mounting system for a compressible conveyor belt drive roller comprises lower and upper bearing assemblies, and in accordance with a first embodiment, a jack screw mechanism is provided for engaging the upper bearing assembly so as to cause axial movement of the upper bearing assembly toward and away from the lower bearing assembly. As a result of such axial movement, the compressible conveyor belt drive roller is axially compressed or expanded so as to accordingly cause radial expansion and contraction of the drive roller. The radial expansion and contraction of the drive roller alters the circumferential extent of the drive roller which alters the conveying speed of a conveyor belt operatively engaged with the outer peripheral surface of the drive roller such that the conveyance speed of the conveyor belt can be synchronized with the conveyance speed of an oppositely disposed paired or companioned conveyor belt. In accordance with a second embodiment of the invention, a pneumatic control system is utilized in lieu of the mechanical jack screw mechanism.

### FIELD OF THE INVENTION

The present invention relates generally to conveyor belt drive systems, and a method of operating the same, and more particularly to a new and improved product or article transportation or conveyor belt drive roller mounting system for incorporation within a product or article transportation or conveyor belt drive system for accurately controlling the operating or running speed of a particular one of two separately-powered, opposed, paired, or companioned product transportation or conveyor belts.

### BACKGROUND OF THE INVENTION

A typical opposed, paired, or companioned product transportation or conveyor belt system conventionally comprises a pair of separately-powered, opposed, paired, or companioned product transportation or conveyor belts which cooperate together so as to transport products or articles, such as, for example, postal mail pieces or the like, which are interposed therebetween. The drive or power rollers for each one of the paired, opposed, or companioned product transportation or conveyor belts conventionally comprises solid metal drive rollers, however, due to inconsistencies and tolerance variations inherent in the diametrical extents or dimensions of such solid metal drive rollers as manufactured in accordance with conventional manufacturing processes and techniques, significant or substantial speed differentials manifest themselves between the paired, opposed, or companioned product transportation or conveyor belts. As a result of such speed differentials between the paired, opposed, or companioned product transportation or conveyor belts, the transporation or conveyor belt system is inordinately noisy, excessive wear of the transportation or conveyor belts has been experienced, and damage to the conveyed articles also occurs resulting in atmospheric suspensions of cellulose particulates or paper dust which presents significant environmental hazards to operator personnel.

A need therefore exists in the art for a new and improved product or article transportation or conveyor belt drive roller mounting system, and a method of operating the same, for incorporation within a product or article transportation or conveyor belt drive system for accurately controlling the operating or running speed of a particular one of two separately-powered, paired, opposed, or companioned product transportation or conveyor belts such that speed differentials between such separately-powered, paired, opposed, or companioned product transportation or conveyor belts is substantially reduced or eliminated so as to, in turn, significantly reduce the operating noise level of the transportation or conveyor belt system, effectively reduce the wear of the transporation or conveyor belts, and effectively reduce collateral damage to the conveyed or transported products or articles.

### OBJECTS OF THE INVENTION

Accordingly, it is an object of the present invention to provide a new and improved product or article transportation or conveyor belt drive roller mounting system, and a method of operating the same, for incorporation within a product or article transportation or conveyor belt drive system for accurately controlling the operating or running speed of a particular one of separately-powered, paired, opposed or companioned product transportation or conveyor belts.

Another object of the present invention is to provide a new and improved product or article transportation or conveyor belt drive roller mounting system, and a method of operating the same, for incorporation within a product or article transportation or conveyor belt drive system for accurately controlling the running or operating speed of a particular one of a separately-powered, opposed, paired, or companioned product transportation or conveyor belts so as to overcome the various operative drawbacks and disadvantages characteristic of conventional product or article transportation or conveyor belt drive systems which utilize solid metal drive rollers.

An additional object of the present invention is to provide a new and improved product or article transportation or conveyor belt drive roller mounting system, and a method of operating the same, for incorporation within a product or article transportation or conveyor belt drive system for accurately controlling the operating or running speed of a particular one of separately-powered, paired, opposed or companioned product transportation or conveyor belts such that speed differentials between such separately-powered, paired, opposed or companioned product transportation or conveyor belts is substantially reduced or eliminated.

A further object of the present invention is to provide a new and improved product or article transportation or conveyor belt drive roller mounting system, and a method of operating the same, for incorporation within a product or article transportation or conveyor belt drive system for accurately controlling the operating or running speed of a particular one of separately-powered, paired, opposed or companioned product transportation or conveyor belts such that speed differentials between such separately-powered, paired, opposed or companioned product transportation or conveyor belts is substantially reduced or eliminated so as to, in turn, significantly reduce the operating noise level of the transportation or conveyor belt system.

A last object of the present invention is to provide a new and improved product or article transportation or conveyor belt drive roller mounting system, and a method of operating the same, for incorporation within a product or article transportation or conveyor belt drive system for accurately controlling the running or operating speed of a particular one of separately-powered, opposed, paired, or companioned product transportation or conveyor belts such that speed differentials between such separately-powered, paired, opposed or companioned product conveyor or transportation belts is substantially reduced or eliminated so as to effectively reduce the wear of the conveyor or transportation belts as well as to effectively reduce collateral damage to the transported or conveyed products or articles.

### SUMMARY OF THE INVENTION

The foregoing and other objectives are achieved in accordance with the teachings and principles of the present invention through the provision of a new and improved product or article transportation or conveyor belt drive roller mounting system, and a method of operating the same, which, in accordance with a first embodiment of the present invention, includes a saddle mount comprising a lower saddle arm which is adapted to be secured to a deck or foundation, and an upper saddle arm which is vertically spaced from the lower saddle arm. A lower bearing support assembly is rotatably mounted within the lower saddle arm and is adapted to be operatively connected to a suitable conveyor roller drive system, and a drive roller, fabricated from a suitable compressible rubber composition having desirable hardness and wear-resistant properties, is mounted upon a roller shaft which is rotatably fixed to the lower bearing support assembly. A jack screw, comprising a jack screw head, is threadedly mounted within the upper saddle arm, and an upper bearing assembly, which is disposed in contact with the upper end portion of the drive roller, is rotatably mounted within the jack screw head. When the jack screw is threadedly rotated within the upper saddle arm such that the jack screw head and upper bearing assembly move axially toward the lower bearing support assembly, the drive roller will be axially compressed and therefore radially or diametrically expanded. Accordingly, since the rotational drive system is maintained at a constant number of revolutions per minute (RPM), the increased diametrical extent of the drive roller causes the effective conveyor belt speed to be increased. In a similar but opposite sense, when the jack screw is threadedly rotated within the upper saddle arm in a reverse mode such that the jack screw head and upper bearing assembly move axially away from the lower bearing support assembly, the drive roller will be permitted to radially or diametrically contract and axially expand whereby the effective conveyor belt speed will be decreased. By means of suitable control of the jack screw mechanism, the effective speed of the conveyor belt can be accurately controlled such that the speed of such conveyor belt can be synchronized with its paired, opposed, or companioned conveyor belt.

In accordance with a second embodiment of the present invention, in lieu of the mechanical screw jack system, a pneumatic control system is utilized. More particularly, the roller shaft is hollow and is provided with a pressurization port. An expansible rubber sleeve or bladder is incorporated internally within the rubber composite drive roller, and the upper end of the roller shaft is fluidically connected to a source of pressurized air through means of a suitable inflation valve. Accordingly, when a predeterminedly controlled amount of pressurized air is admitted into the hollow roller shaft and discharged through means of the air pressurization port so as to inflate the rubber sleeve or bladder, the rubber sleeve or bladder will be radially expanded so as to in turn cause radial expansion of the composite rubber drive roller in a manner similar to that achieved in connection with the drive roller of the first embodiment when subjected to the mechanical forces of the jack screw system.

### BRIEF DESCRIPTION OF THE DRAWINGS

Various other objects, features, and attendant advantages of the present invention will be more fully appreciated from the following detailed description when considered in connection with the accompanying drawings in which like reference characters designate like or corresponding parts throughout the several views, and wherein:

FIG. 1 is a side elevational view of a first embodiment of a new and improved product or article transportation or conveyor belt drive roller mounting system, having a mechanical jack screw actuation system incorporated therein, which has been constructed in accordance with the principles and teachings of the present invention and which shows the cooperative parts thereof;

FIG. 2 is a perspective view of the first embodiment of the new and improved product or article transportation or conveyor belt drive roller mounting system as disclosed within FIG. 1; and

FIG. 3 is a perspective view of a second embodiment of a new and improved product or article transportation or conveyor belt drive roller mounting system, having a pneumatic actuation system incorporated therein, which has also been constructed in accordance with the principles and teachings of the present invention and which shows the cooperative parts thereof.

### DETAILED DESCRIPTION OF THE PREFERRED EMBODIMENT

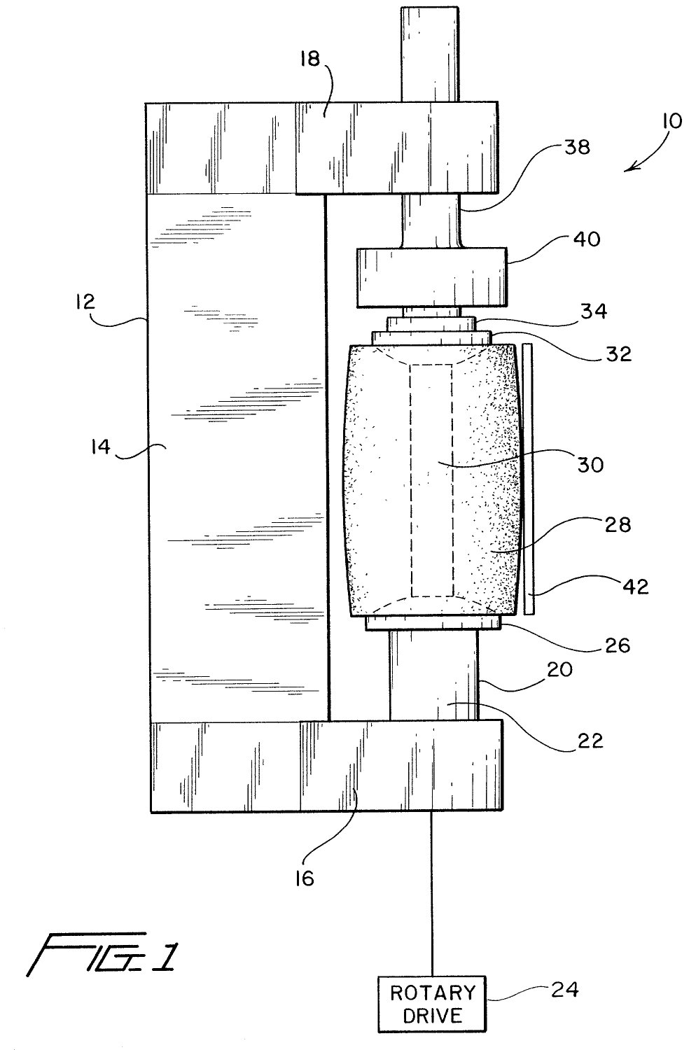

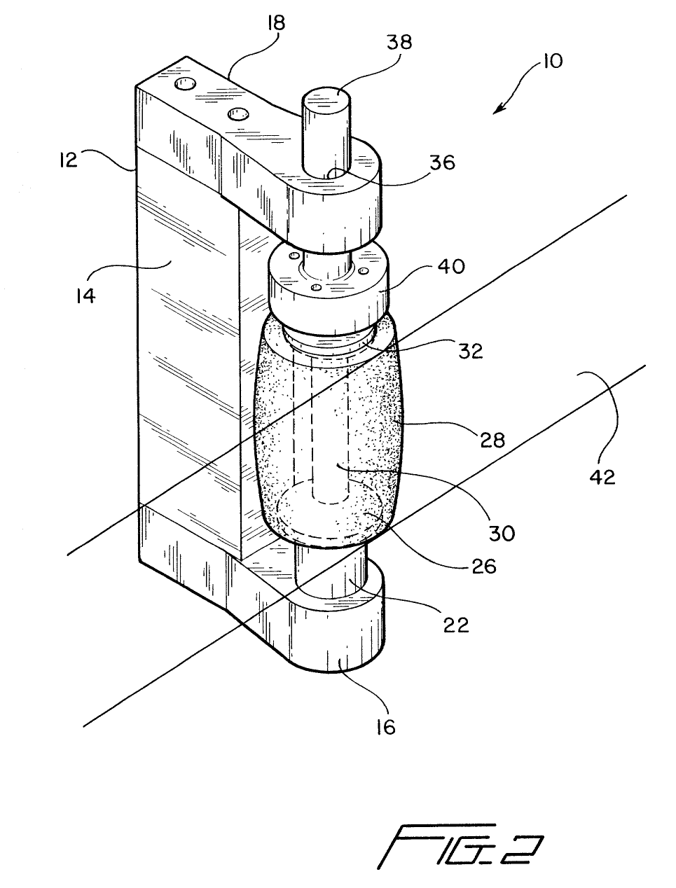

Referring now to the drawings, and more particularly to FIGS. 1 and 2 thereof, a first embodiment of a new and improved product or article transportation or conveyor belt drive roller mounting system, which has been constructed in accordance with the principles and teachings of the present invention, is disclosed and is generally indicated by the reference character 10. As can be readily appreciated from the drawings, the new and improved product or article transportation or conveyor belt drive roller mounting system 10 is seen to comprise a saddle type mounting structure 12 which includes a vertically oriented and up-standing mounting block 14 which has a first lower saddle arm 16 and a second upper saddle arm 18 integrally fixed thereto at vertically spaced opposite ends thereof. The lower saddle arm 16 is adapted to be fixed upon an underlying deck, foundation, or support surface, not shown, by means of bolt fasteners or the like, also not shown, and the lower saddle arm 16 has a bearing mechanism, also not shown, disposed therein for rotatably supporting a lower bearing support assembly 20 about a vertical axis. More particularly, the lower bearing support assembly 20 is seen to comprise a first, upstanding lower bearing support shaft 22 wherein the lower end portion of the lower bearing support shaft 22 is operatively connected to a suitable rotary drive unit 24, although it is noted further that the lower bearing support assembly 20 is axially fixed.

The upper end portion of the lower bearing support shaft 22 has a first, lower, convexly-shaped compression support plate 26 integrally formed thereon, and in accordance with a first unique and novel feature characteristic of the present invention, the first, lower, convexly-shaped compression support plate 26 is adapted to have mounted and supported thereon a first lower axial end of a conveyor belt drive roller 28. The conveyor belt drive roller 28 is fabricated from a suitable compressible rubber composition having desirable hardness and wear-resistant properties, and it is further seen that the drive roller 28 is rotatably mounted upon a coaxially oriented roller shaft 30. The lower end of the roller shaft 30 is fixedly mounted within the lower bearing support assembly 20 by means of, for example, an interference or press fit so as to rotate with the lower bearing support shaft 22 and the lower compression support plate 26, however, the upper end of the roller shaft 30 is slidably disposed within, and relative to, a second, upper, convexly-shaped compression support plate 32 which forms part of an upper bearing support assembly 34 coaxially disposed with respect to the lower bearig support assembly 20.

As can best be seen from FIG. 2, the upper saddle arm 18 is provided with an internally threaded through-bore 36 within which an externally threaded jack screw shaft 38 is threadedly disposed. The upper end portion of the jack screw shaft 38 projects or extends above the upper surface portion of the upper saddle arm 18 so as to be readily accessible for manual rotation by means of an operator using a suitable wrench-type tool or the like, not shown, whereas the lower end portion of the jack screw shaft 38 is integrally provided with a jack screw head 40. The jack screw head 40 is provided with an internal bearing assembly, not shown, by means of which the upper end portion of the upper bearing support assembly 34 may be rotatably disposed and supported, while concomitantly, the jack screw head 40 can bear downwardly upon the upper bearing support assembly 34 so as to, in turn, force or cause the second, upper, convexly-shaped compression support plate 32 to move axially downwardly along the roller shaft 30 so as to be forcefully engaged into contact with the upper axial end portion of the conveyor drive roller 28.

In this manner, it can readily be appreciated that when the jack screw shaft 38 is rotated a predetermined amount in a predetermined direction such that the jack screw head 40 is moved axially downwardly so as to in turn force the upper compression support plate 32 axially downwardly along the conveyor roller shaft 30 and toward the oppositely disposed lower compression support plate 26, the upper compression support plate 32 will effectively cooperate with the lower compression support plate 26 whereby the conveyor belt drive roller 28 will be axially compressed a predetermined amount and correspondingly radially expanded a predetermined amount. It therefore follows further that, in view of the known relationship between the radial or diametrical extent of an object, such as roller 28, and the circumferential extent of such object, that is, in view of the fact that the circumference of the object is equal to 2πr or πd, then the circumferential extent of the roller will be increased a predetermined amount.

Accordingly, in view of the additional fact that the rotary drive 24 is rotating the lower bearing support shaft 22, and therefore, the conveyor belt drive roller 28, at a rotational rate comprising a predetermined number of revolutions per minute (RPM), the radially expanded conveyor belt drive roller 28 will cause the conveyance speed of the conveyor belt 42, which is disposed in driven contact with the outer peripheral or circumferential surface portion of the conveyor belt drive roller 28, to be increased a predetermined amount. Therefore, it can be further readily appreciated that as a result of controlling the disposition of the upper compression support plate 32 by means of the jack screw assembly comprising jack screw shaft 38 and jack screw head 40, the radial or diametrical extent of the conveyor belt drive roller 28 can be controlled so as to in turn control the conveyance speed of the conveyor belt 42. Consequently, the conveyance speed of the conveyor belt 42 can effectively be synchronized with the conveyance speed of its oppositely disposed paired or companioned conveyor belt, not shown. It is also noted that in connection with such aforenoted alteration of the axial compression and radial expansion of the conveyor belt drive roller 28, and the consequent alteration in the conveyance speed of the conveyor belt 42, that such alterations or adjustments in the conveyance speed of the conveyor belt 42 can be accomplished dynamically, that is, while the conveyor belt drive system is in operation.

In a similar but opposite manner, when the jack screw shaft 38 is rotated a predetermined amount in an opposite direction such that the jack screw head 40 is moved axially upwardly so as to in turn permit in effect the upper compression support plate 32 to move axially upwardly along the conveyor roller shaft 30 and away from the oppositely disposed lower compression support plate 26, the upper compression support plate 32 will effectively cooperate with the lower compression support plate 26 so as to relieve the axial pressure or force previously impressed upon the conveyor belt drive roller 28 whereby the conveyor belt drive roller 28 will axially expand a predetermined amount and correspondingly radially contract a predetermined amount. It therefore follows further that, in view of the aforenoted known relationship between the radial or diametrical extent of the conveyor belt drive roller 28, and the circumferential extent of the conveyor belt drive roller 28, then the circumferential extent of the roller will be decreased a predetermined amount. Accordingly, in view of the aforenoted fact that the rotary drive 24 is rotating the lower bearing support shaft 22, and therefore, the conveyor belt drive roller 28, at a rotational rate comprising a predetermined number of revolutions per minute (RPM), the radially contracted conveyor belt drive roller 28 will permit the conveyance speed of the conveyor belt 42, which is disposed in driven contact with the outer peripheral or circumferential surface portion of the conveyor belt drive roller 28, to be decreased a predetermined amount. Accordingly, it can be further readily appreciated that as a result of controlling the disposition of the upper compression support plate 32 by means of the jack screw assembly comprising jack screw shaft 38 and jack screw head 40, the radial or diametrical extent of the conveyor belt drive roller 28 can be controlled so as to in turn control the conveyance speed of the conveyor belt 42. Consequently, the conveyance speed of the conveyor belt 42 can effectively be synchronized with the conveyance speed of its oppositely disposed paired or companioned conveyor belt, not shown. As was the case with the aforenoted axial compression and radial expansion of the conveyor belt drive roller 28, it is also noted that such alterations or adjustments in the conveyance speed of the conveyor belt 42 can be accomplished dynamically, that is, while the conveyor belt drive system is in operation.

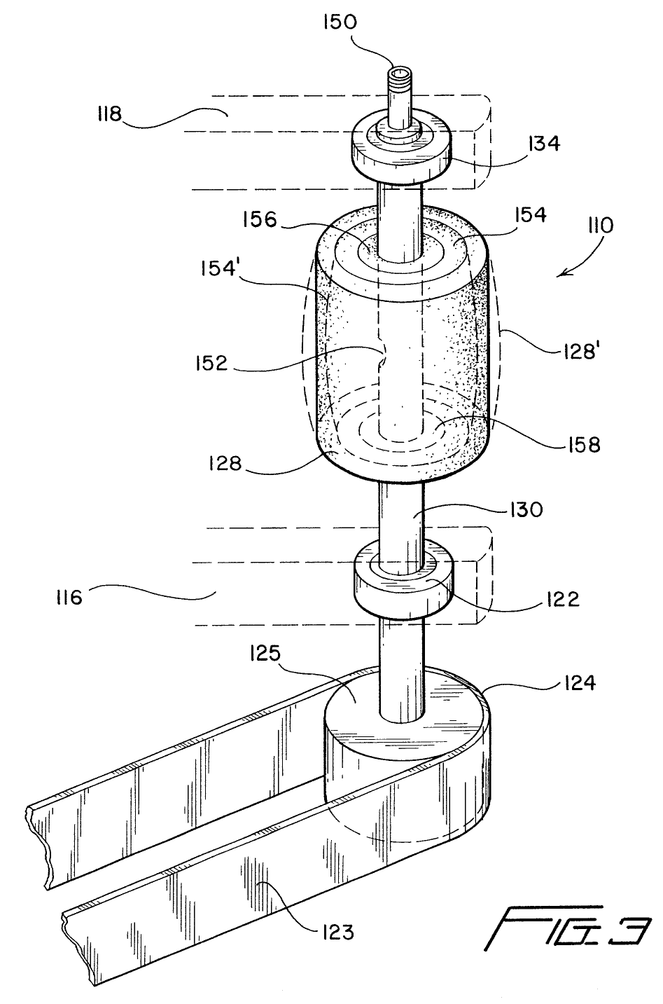

With reference now being made to FIG. 3, a second embodiment of a new and improved product or article conveyor or transportation belt drive roller mounting system, which has also been constructed in accordance with the principles and teachings of the present invention, is disclosed and is generally indicated by the reference character 110. It is to be noted that both of the drive roller mounting systems 10,110 are similar in operation, although as will be noted hereinafter, the means employed within the respective systems 10,110, for actuating or controlling the axial compression and radial expansion of the conveyor belt drive roller, are different, and consequently, components parts of the system 110, which are similar to corresponding component parts of the system 10, will be designated by similar reference numbers except that the reference numbers will be within the 100 series. In addition, in view of the structural similarity between the systems 10,110, for the purposes of brevity, the following discussion of the system 110 will be directed only toward the differences between the two systems 10,110.

More particularly, as can be seen from FIG. 3, the conveyor belt drive roller is shown at 128, and the drive roller shaft is shown at 130. The lower end portion of the drive roller shaft 130 is operatively connected to a rotary drive system 124 which comprises a drive belt 123 and a driven pulley 125, and a lower portion of the drive roller shaft 130 is also operatively associated with a lower bearing support assembly 122 which is adapted to be mounted internally within a lower saddle arm 116. In a similar manner, an upper portion of the drive roller shaft 130 is adapted to be operatively associated with an upper bearing support assembly 134 which, in turn, is adapted to be mounted within an upper saddle arm 118, wherein, in a manner similar to the first embodiment, the upper and lower saddle arms 118,116 form integral parts of a saddle assembly which comprises a vertically oriented and upstanding saddle mounting block, not shown in FIG. 3.

Continuing further, the drive roller shaft 130 is fabricated as a hollow tubular member, and the upper saddle arm 118 has an inflation valve 150 mounted therein. The inflation valve 150 is adapted to be fluidically connected at desirable times to a suitable source of pressurized air, not shown, and the pressurized air can be routed, for example, through the upper bearing support assembly 134, by means not shown, such that the pressurized air can be fluidically introduced into the interior of the drive roller shaft 130 in a sealed manner. An axially central or intermediate side wall portion of the drive roller shaft 130 is further provided with a pressurization port 152 which opens into the interior of the drive roller 128 which, in this instance, is fabricated as a cylindrical tube from a suitable rubber composition. A rubber bladder or sleeve member 154 is disposed internally within the tubular drive roller 128, and a pair of upper and lower annular seal members 156,158 are press-fitted upon the drive roller shaft 130. The upper and lower end portions of the rubber bladder or sleeve member 154 are in turn bonded to the annular seal members 156,158 in order to hermetically seal the roller shaft-upper and lower seal members-rubber bladder assembly 130-156,158-154. Accordingly, when the source of compressed air, not shown, is fluidically connected to the inflation valve 150, pressurized air will be conducted into the interior of the drive roller shaft 130, and will be discharged through pressurization port 152 so as to controllably inflate and radially expand the rubber bladder or sleeve member 154 which will, in turn, cause a corresponding radial expansion of the drive roller 128.

Having therefore described the structure comprising the second embodiment of the new and improved dynamically variable-diameter product or article conveyor or transportation belt drive roller mounting system 110 as shown in FIG. 3, which has likewise been constructed in accordance with the teachings and principles of the present, the operation of the same will now be described. When it is desired, for example, to alter the radial or diametrical extent of the drive roller 128 so as to correspondingly alter the circumferential extent thereof, and therefore, the conveying speed of the operatively associated conveyor belt, as has been discussed hereinbefore in connection with the first embodiment system 10 as disclosed within FIGS. 1 and 2, the inflation valve 150 is operatively connected to the source of pressurized air, not shown, whereby the compressed air will serve to inflate and radially expand the rubber sleeve member or bladder 154 in a controlled manner, as shown at 154′, so as to correspondingly radially expand the drive roller 128 to the position or state shown at 128′. It therefore follows that, as has been noted hereinbefore, in view of the known relationship between the radial or diametrical extent of an object, such as roller 128, and the circumferential extent of such object, that is, in view of the fact that the circumference of the object is equal to 2πr or πd, then the circumferential extent of the roller 128 will be increased a predetermined amount. Accordingly, still further, in view of the additional fact that the rotary drive 124 is rotating the lower end portion of the roller shaft 130, through means of the lower bearing assembly 122, and therefore, the conveyor belt drive roller 128, at a rotational rate comprising a predetermined number of revolutions per minute (RPM), the radially expanded conveyor belt drive roller 128 will cause the conveyance speed of a conveyor belt, not shown but operably disposed in driven contact with the outer peripheral or circumferential surface portion of the conveyor belt drive roller 128, to be increased a predetermined amount. Therefore, it can be further readily appreciated that as a result of controlling the degree to which the drive roller 128 is radially expanded by means of the radial expansion of the rubber bladder or sleeve member 154, the conveyance speed of the conveyor belt, not shown, can be desirably controlled. Consequently, the conveyance speed of the conveyor belt, not shown, can effectively be synchronized with the conveyance speed of its oppositely disposed companioned or paired conveyor belt, also not shown. It is also noted, as was the case with the first embodiment of the invention, the alterations in the conveyance speed of the conveyor belt, not shown, can be accomplished dynamically, that is, while the conveyor belt drive system is in operation.

It is also to be appreciated that in a similar but opposite manner, when, for example, pressurized air is in effect bled from the interior of the rubber sleeve or bladder member 154, the rubber sleeve or bladder member 154, and therefore the conveyor belt drive roller 128, will undergo a predetermined amount of radial contraction. It therefore follows that, in view of the aforenoted known relationship between the radial or diametrical extent of the conveyor belt drive roller 128, and the circumferential extent of the conveyor belt drive roller 128, then the circumferential extent of the drive roller 128 will be decreased a predetermined amount. Accordingly, in view of the aforenoted fact that the rotary drive 124 is rotating the lower end portion of the roller shaft 130, through means of the lower bearing assembly 122, and therefore, the conveyor belt drive roller 128, at a rotational rate comprising a predetermined number of revolutions per minute (RPM), the radially contracted conveyor belt drive roller 128 will permit the conveyance speed of the conveyor belt, not shown, which is disposed in driven contact with the outer peripheral or circumferential surface portion of the conveyor belt drive roller 128, to be decreased a predetermined amount. Consequently, the conveyance speed of the conveyor belt, not shown, can effectively be synchronized with the conveyance speed of its oppositely disposed paired or companioned conveyor belt, also not shown. As was the case with the aforenoted radial expansion of the conveyor belt drive roller 128, it is also noted that such alterations or adjustments in the conveyance speed of the conveyor belt, not shown, can be accomplished dynamically, that is, while the conveyor belt drive system is in operation.

Thus, it may be seen that in accordance with the principles and teachings of the present invention, a new and improved product or article transportation or conveyor belt drive roller mounting system has been developed by means of which the outer circumferential extent of the conveyor drive roller can be dynamically altered so as to correspondingly alter the conveyance speed of the conveyor belt operatively associated therewith. In this manner, the conveyance speed of such conveyor belt can be optimally synchronized with the conveyance speed of an operatively associated, oppositely disposed paired or companioned conveyor belt.

From the foregoing, it can be appreciated that many variations and modifications of the present invention are possible in light of the above teachings. For example, while the fluidic control of the conveyor belt drive roller 128 has been noted as being pneumatic, it is also possible to hydraulically control the expansion and contraction of the conveyor belt drive roller 128. Still further, while a jack screw mechanism 38,40 has been disclosed as the driving mechanism for the embodiment of FIGS. 1 and 2, it is also possible to utilized, for example, a suitable solenoid-activated mechanism. It is therefore to be understood that within the scope of the appended claims, the present invention may be practiced otherwise than as specifically described herein.

What is claimed as new and desired to be protected by Letters Patent of the United States of America, is:

1. A mounting system for a conveyor belt drive roller of a conveyor belt drive system, comprising:
a compressible conveyor belt drive roller adapted to have its external peripheral surface disposed in contact with a conveyor belt so as to drive the conveyor belt along a conveying path;
a first bearing support assembly for rotatably supporting a first axial end of said conveyor belt drive roller;
a second bearing support assembly for rotatably supporting a second axial end of said conveyor belt drive roller; and
means operatively associated with said second bearing support assembly for moving said second bearing support assembly axially toward and away from said first bearing support assembly so as to respectively cause axial compression, and permit axial expansion, of said compressible conveyor belt drive roller and thereby cause radial expansion and radial contraction of said compressible conveyor belt drive roller so as to alter the circumferential extent of said compressible conveyor belt drive roller and thereby in turn alter the conveyance speed of the conveyor belt disposed in contact with said external peripheral surface of said compressible conveyor belt drive roller.

2. A mounting system as set forth in claim 1, further comprising:
a first support arm for supporting said first bearing support assembly; and
a second support arm;
said means for moving said second bearing support assembly toward and away from said first bearing support assembly comprises a jack screw mechanism mounted within said second support arm and operatively associated with said second bearing support assembly.

3. A mounting system as set forth in claim 2, wherein:
said first support arm and said second support arm comprise parts of a saddle assembly comprising a saddle block having said first support arm fixedly mounted upon a first end of said saddle block while said second support arm is fixedly mounted upon a second opposite end of said saddle block.

4. A mounting system as set forth in claim 3, wherein:
said second support arm has an internally threaded bore defined therein; and
said jack screw mechanism comprises an externally threaded shaft threadedly disposed within said internally threaded bore of said second support arm, and a jack screw head integrally formed upon said jack screw shaft for engagement with said second bearing support assembly for moving said second bearing support assembly toward and away from said first bearing support assembly.

5. A mounting system as set forth in claim 1, wherein:
said compressible conveyor belt drive roller is rotatably mounted upon a roller shaft;
a first end portion of said roller shaft is fixedly mounted within said first bearing support assembly; and
said second bearing support assembly is axially movable upon a second end portion of said roller shaft.

6. A mounting system as set forth in claim 4, wherein:
said saddle block is vertically oriented such that said first and second support arms are vertically spaced from each other upon first lower and second upper end portions of said saddle block;
said first bearing support assembly projects vertically upwardly from said first lower support arm; and
said jack screw mechanism projects vertically downwardly from said second upper support arm.

7. A mounting system as set forth in claim 1, wherein:
said compressible conveyor belt drive roller is fabricated from a rubber composition having suitable hardness and wear-resistant properties.

8. A mounting system as set forth in claim 1, further comprising:
rotary drive means operatively connected to said first bearing support assembly for imparting rotation to said first bearing support assembly for in turn rotating said conveyor belt drive roller at a predetermined rate of revolution.

9. A conveyor belt drive system for conveying a first conveyor belt of a set of oppositely disposed paired and companioned conveyor belts, comprising:
a conveyor belt;
a compressible conveyor belt drive roller adapted to have its external peripheral surface disposed in contact with said conveyor belt so as to drive said conveyor belt along a conveying path;
a first bearing support assembly for rotatably supporting a first axial end of said conveyor belt drive roller;
rotary drive means operatively connected to said first bearing support assembly for imparting rotation to said first bearing support assembly for in turn rotating said conveyor belt drive roller at a predetermined rate of revolution;
a second bearing support assembly for rotatably supporting a second axial end of said conveyor belt drive roller; and
means operatively associated with said second bearing support assembly for moving said second bearing support assembly axially toward and away from said first bearing support assembly so as to respectively cause axial compression, and permit axial expansion, of said compressible conveyor belt drive roller and thereby cause radial expansion and radial contraction of said compressible conveyor belt drive roller so as to alter the circumferential extent of said compressible conveyor belt drive roller and thereby in turn alter the conveyance speed of said conveyor belt disposed in contact with said external peripheral surface of said compressible conveyor belt drive roller such that said conveyance speed of said conveyor belt can be synchronized with its oppositely disposed paired and companioned conveyor belt.

10. A drive system as set forth in claim 9, further comprising:
a first support arm for supporting said first bearing support assembly; and
a second support arm;
said means for moving said second bearing support assembly toward and away from said first bearing support assembly comprises a jack screw mechanism mounted within said second support arm and operatively associated with said second bearing support assembly.

11. A drive system as set forth in claim 10, wherein:
said first support arm and said second support arm comprise parts of a saddle assembly comprising a saddle block having said first support arm fixedly mounted upon a first end of said saddle block while said second support arm is fixedly mounted upon a second opposite end of said saddle block.

12. A drive system as set forth in claim 11, wherein:
said second support arm has an internally threaded bore defined therein; and
said jack screw mechanism comprises an externally threaded shaft threadedly disposed within said internally threaded bore of said second support arm, and a jack screw head integrally formed upon said jack screw shaft for engagement with said second bearing support assembly for moving said second bearing support assembly toward and away from said first bearing support assembly.

13. A drive system as set forth in claim 9, wherein:
said compressible conveyor belt drive roller is rotatably mounted upon a roller shaft;
a first end portion of said roller shaft is fixedly mounted within said first bearing support assembly; and
said second bearing support assembly is axially movable upon a second end portion of said roller shaft.

14. A drive system as set forth in claim 12, wherein:
said saddle block is vertically oriented such that said first and second support arms are vertically spaced from each other upon first lower and second upper end portions of said saddle block;
said first bearing support assembly projects vertically upwardly from said first lower support arm; and
said jack screw mechanism projects vertically downwardly from said second upper support arm.

15. A drive system as set forth in claim 9, wherein:
said compressible conveyor belt drive roller is fabricated from a rubber composition having suitable hardness and wear-resistant properties.

16. A drive system as set forth in claim 9, further comprising:
rotary drive means operatively connected to said first bearing support assembly for imparting rotation to said first bearing support assembly for in turn rotating said conveyor belt drive roller at a predetermined rate of revolution.

17. A mounting system for a conveyor belt drive roller of a conveyor belt drive system, comprising:
a conveyor belt drive roller shaft;
an expansible and contractible conveyor belt drive roller mounted upon said conveyor belt drive roller shaft and adapted to have its external peripheral surface disposed in contact with a conveyor belt so as to drive the conveyor belt along a conveying path;
a first bearing support assembly for rotatably supporting a first axial end of said conveyor belt drive roller shaft;
a second bearing support assembly for rotatably supporting a second axial end of said conveyor belt drive roller shaft; and
means for fluidically connecting an interior portion of said expansible and contractible conveyor belt drive roller to an external source of pressurized fluid for controllably radially expanding and contracting said expansible conveyor belt drive roller so as to alter the circumferential extent of said radially expansible and contractible conveyor belt drive roller and thereby in turn alter the conveyance speed of the conveyor belt disposed in contact with said external peripheral surface of said expansible and contractible conveyor belt drive roller.

18. A mounting system as set forth in claim 17, wherein:
said roller shaft comprises a hollow tubular member;
a pressurization valve is adapted to be fluidically connected to a source of pressurized fluid and is fluidically connected to said tubular roller shaft; and
a pressurization port is formed within a peripheral side wall of said tubular roller shaft so as to fluidically open into said interior portion of said expansible and contractible conveyor belt drive roller and thereby provide pressurized fluid from said pressurization valve to said interior portion of said expansible and contractible conveyor belt drive roller.

19. A mounting system as set forth in claim 18, further comprising:
an expansible and contractible bladder disposed internally within said expansible and contractible conveyor belt drive roller and fluidically connected to said pressurization port of said roller shaft for receiving said pressurized fluid so as to expand said expansible conveyor belt drive roller as said expansible bladder is expanded by said pressurized fluid.

20. A mounting system as set forth in claim 17, further comprising:
rotary drive means operatively connected to said first axial end of said conveyor belt drive roller shaft for imparting rotation to said expansible and contractible conveyor belt drive roller at a predetermined rate of revolution.

21. A conveyor belt drive system for conveying a conveyor belt of a set of oppositely disposed paired and companioned conveyor belts, comprising:
a conveyor belt;
a conveyor belt drive roller shaft;
an expansible and contractible conveyor belt drive roller mounted upon said conveyor belt drive roller shaft and adapted to have its external peripheral surface disposed in contact with said conveyor belt so as to drive said conveyor belt along a conveying path;
a first bearing support assembly for rotatably supporting a first axial end of said expansible and contractible conveyor belt drive roller;
rotary drive means operatively connected to said first axial end of said conveyor belt drive roller shaft for imparting rotation to said expansible and contractible conveyor belt drive roller at a predetermined rate of revolution;
a second bearing support assembly for rotatably supporting a second axial end of said expansible and contractible conveyor belt drive roller; and
means for fluidically connecting an interior portion of said expansible and contractible conveyor belt drive roller to an external source of pressurized fluid for controllably radially expanding and contracting said expansible and contractible conveyor belt drive roller so as to alter the circumferential extent of said radially expansible and contractible conveyor belt drive roller and thereby in turn alter the conveyance speed of said conveyor belt disposed in contact with said external peripheral surface of said expansible and contractible conveyor belt drive roller such that said conveyance speed of said conveyor belt can be synchronized with its oppositely disposed paired and companioned conveyor belt.

22. A drive system as set forth in claim 21, wherein:
said roller shaft comprises a hollow tubular member;
a pressurization valve is adapted to be fluidically connected to a source of pressurized air and is fluidically connected to said tubular roller shaft; and
a pressurization port is formed within a peripheral side wall of said tubular roller shaft so as to fluidically open into said interior portion of said expansible and contractible conveyor belt drive roller and thereby provide pressurized fluid from said pressurization valve to said interior portion of said expansible and contractible conveyor belt drive roller.

23. A drive system as set forth in claim 22, further comprising:
an expansible and contractible bladder disposed internally within said expansible and contractible conveyor belt drive roller and fluidically connected to said pressurization port of said roller shaft for receiving said pressurized fluid so as to expand said expansible and contractible conveyor belt drive roller as said expansible and contractible bladder is expanded by said pressurized fluid.

24. A mounting system for a conveyor belt drive roller of a conveyor belt drive system, comprising:
a radially expansible and contractible conveyor belt drive roller adapted to have its external peripheral surface disposed in contact with a conveyor belt so as to drive the conveyor belt along a conveying path;
a first bearing support assembly for rotatably supporting a first axial end of said radially expansible and contractible conveyor belt drive roller;
a second bearing support assembly for rotatably supporting a second axial end of said radially expansible and contractible conveyor belt drive roller; and
means operatively acting upon said radially expansible and contractible conveyor belt drive roller for causing radial expansion and radial contraction of said radially expansible and contractible conveyor belt drive roller so as to alter the circumferential extent of said radially expansible and contractible conveyor belt drive roller and thereby in turn alter the conveyance speed of the conveyor belt disposed in contact with said external peripheral surface of said radially expansible and contractible conveyor belt drive roller.

25. The mounting system as set forth in claim 24, wherein:
said means operatively acting upon said radially expansible and contractible conveyor belt drive roller comprises a jack screw system for causing axial compression and expansion of said radially expansible and contractible conveyor belt drive roller.

26. The mounting system as set forth in claim 24, wherein:
said means operatively acting upon said radially expansible and contractible conveyor belt drive roller comprises a fluid control system fluidically connected to an expansible and contractible bladder disposed internally within said radially expansible and contractible conveyor belt drive roller.

27. A conveyor belt drive system for conveying a first conveyor belt of a set of oppositely disposed paired and companioned conveyor belts, comprising:
a conveyor belt;
a radially expansible and contractible conveyor belt drive roller adapted to have its external peripheral surface disposed in contact with said conveyor belt so as to drive said conveyor belt along a conveying path;
a first bearing support assembly for rotatably supporting a first axial end of said radially expansible and contractible conveyor belt drive roller;
a second bearing support assembly for rotatably supporting a second axial end of said radially expansible and contractible conveyor belt drive roller; and
means operatively acting upon said radially expansible and contractible conveyor belt drive roller for causing radial expansion and radial contraction of said radially expansible and contractible conveyor belt drive roller so as to alter the circumferential extent of said radially expansible and contractible conveyor belt drive roller and thereby in turn alter the conveyance speed of said conveyor belt disposed in contact with said external peripheral surface of said radially expansible and contractible conveyor belt drive roller such that said conveyance speed of said conveyor belt can be synchronized with its oppositely disposed paired and companioned conveyor belt.

28. The drive system as set forth in claim 27, wherein:
said means operatively acting upon said radially expansible and contractible conveyor belt drive roller comprises a jack screw system for causing axial compression and expansion of said radially expansible and contractible conveyor belt drive roller.

29. The drive system as set forth in claim 27, wherein:
said means operatively acting upon said radially expansible and contractible conveyor belt drive roller comprises a fluid control system fluidically connected to an expansible and contractible bladder disposed internally within said radially expansible and contractible conveyor belt drive roller.

30. A method of mounting a conveyor belt drive roller of a conveyor belt drive system, comprising the steps of:
providing a radially expansible and contractible conveyor belt drive roller adapted to have its external peripheral surface disposed in contact with a conveyor belt so as to drive the conveyor belt along a conveying path;
rotatably supporting a first axial end of said radially expansible and contractible conveyor belt drive roller;
rotatably supporting a second axial end of said radially expansible and contractible conveyor belt drive roller; and
causing radial expansion and contraction of said radially expansible and contractible conveyor belt drive roller so as to alter the circumferential extent of said radially expansible and contractible conveyor belt drive roller and thereby in turn alter the conveyance speed of the conveyor belt disposed in contact with said external peripheral surface of said radially expansible and contractible conveyor belt drive roller.

31. A method of driving a conveyor belt of a set of oppositely disposed paired and companioned conveyor belts, comprising the steps of:
providing a conveyor belt;
providing a radially expansible and contractible conveyor belt drive roller adapted to have its external peripheral surface disposed in contact with said conveyor belt so as to drive said conveyor belt along a conveying path;
rotatably supporting a first axial end of said radially expansible and contractible conveyor belt drive roller;
rotatably supporting a second axial end of said radially expansible and contractible conveyor belt drive roller; and
causing radial expansion and contraction of said radially expansible and contractible conveyor belt drive roller so as to alter the circumferential extent of said radially expansible and contractible conveyor belt drive roller and thereby in turn alter the conveyance speed of said conveyor belt disposed in contact with said external peripheral surface of said radially expansible and contractible conveyor belt drive roller such that said conveyance speed of said conveyor belt can be synchronized with its oppositely disposed paired and companioned conveyor belt.
